(19) United States
(12) Patent Application Publication
(10) Pub. No.: US 2018/0365769 A1
(43) Pub. Date: Dec. 20, 2018

(54) INFORMATION PROCESSING APPARATUS, METHOD AND NON-TRANSITORY COMPUTER-READABLE STORAGE MEDIUM

(71) Applicant: FUJITSU LIMITED, Kawasaki-shi (JP)

(72) Inventors: Yuji Yamaoka, Kawasaki (JP); Hiroshi OGASAWARA, Sagamihara (JP); Yuji KOTERA, Setagaya (JP); Takahiro Akutsu, Kawaguchi (JP); Kouichi ITOH, Kawasaki (JP)

(73) Assignee: FUJITSU LIMITED, Kawasaki-shi (JP)

(21) Appl. No.: 15/993,915

(22) Filed: May 31, 2018

(30) Foreign Application Priority Data
Jun. 15, 2017 (JP) 2017-117420

(51) Int. Cl. G06Q 40/08; G07C 5/00; G07C 5/08

(52) U.S. Cl. CPC G06Q 40/08; G07C 5/085; G07C 5/008

(57) ABSTRACT

An information processing apparatus is configured to, regarding each of a plurality of objects, acquire a record including location information of an object, speed information of the object, time information that represents a time at which the location information and the speed information have been acquired, and identification information of the object, identify a first record including the identification information corresponding to a target object, the time information corresponding to a target time section, and the location information corresponding to a target space section, identify a plurality of second records each of which includes the time information corresponding to the target time section and the location information corresponding to the target space section, identify a degree of risk of the target object based on difference between a representative value of the speed information included in the plurality of second records and the speed information included in the first record.

### CROSS-REFERENCE TO RELATED APPLICATION

This application is based upon and claims the benefit of priority of the prior Japanese Patent Application No. 2017-117420, filed on Jun. 15, 2017, the entire contents of which are incorporated herein by reference.

### FIELD

The embodiments discussed herein are, related to an information processing apparatus, a method and a non-transitory computer-readable storage medium.

### BACKGROUND

To safely move a moving object such as an automobile, it is important to move the moving object at an appropriate speed. For example if the traveling speed of an automobile is too high, the possibility that an accident is caused becomes high.

Therefore, there is a system to determine the risk according to the speed of a moving object such as an automobile. For example, among automobile insurances, there is a driving behavior-based telematics insurance in which the insurance premium is varied according to the measured speed of an automobile. In the driving behavior-based telematics insurance, a server in an insurance company collects information on the movement speed and so forth of an automobile driven by a policyholder from e.g. a car navigation system mounted on the automobile. After carrying out the collection of the information for a certain period, the server in the insurance company calculates the maximum speed and average speed of the automobile from the history of the speed of the automobile driven by the policyholder in the relevant period. Then, the server in the insurance company determines the risk of the automobile driven by the policyholder by using the maximum speed and average speed of the automobile driven by the policyholder. In the insurance company, the risk of the automobile driven by the policyholder is used as one of indexes for calculating the insurance premium of the policyholder,

The moving object as the measurement target of the speed in the technique to carry out analysis with use of the speed of the moving object is not limited to the vehicle such as the automobile. For example, the pedestrian is also included in the moving object. As a technique to carry out analysis based on the speed of the pedestrian, there is a navigation system that optimizes the connection time at a connection place to the transfer time according to the actual situation and makes a route search to allow the optimum guide route to be presented. Japanese Laid-open Patent Publication No. 2006-193020 exists, as a related-art document.

### SUMMARY

According to an aspect of the invention, an information processing apparatus includes a memory configured to store first information that represents a target object, second information that represents a target time section, and third information that represents a target space section, and a processor coupled to the memory and configured to, regarding each of a plurality of objects, acquire a record including location information that represents a location of the object, speed information that represents a movement speed of the object, time information that represents a time at which the location information and the speed information have been acquired, and identification information of the object, identify, from the plurality of records, a first record including the identification information corresponding to the target object, the time information corresponding to the target time section, and the location information corresponding to the target space section, identify, from the plurality of records, a plurality of second records each of which includes the time information corresponding to the target time section and the location information corresponding to the target space section, identify a degree of risk of the target object based on difference between a representative value of the speed information included in the plurality of second records and the speed information included in the first record, and output the identified degree of risk.

This object and advantages of the invention will be realized and attained by means of the elements and combinations particularly pointed out in the claims.

It s to be understood that both the foregoing general description and the following detailed description are exemplary and explanatory and are not restrictive of the invention, as claimed,

### BRIEF DESCRIPTION OF DRAWINGS

FIG. 1 is a diagram illustrating one example of a degree-of-risk calculating apparatus according to a first embodiment;

FIG. 2 is a diagram illustrating a system configuration example of a second embodiment;

FIG. 3 is a diagram illustrating one configuration example of hardware of a vehicle speed management server used for the second embodiment;

FIG. 4 is a diagram illustrating one configuration example of hardware of in-car equipment;

FIG. 5 is a block diagram illustrating functions of vehicle speed management server;

FIG. 6 is a diagram rating one example of a traveling data management table;

FIG. 7 is a diagram illustrating one example of a time-space-section-specific traveling data group in units of one minute;

FIG. 8 is a diagram illustrating one example of a time-space-section-specific traveling data group in units of one second;

FIG. 9 is a diagram illustrating one example of a representative speed table in units of one minute;

FIG. 10 is a diagram illustrating one example of a representative speed table in units of one second;

FIG. 11 is a diagram illustrating a calculation example of a degree of risk;

FIG. 12 is a flowchart illustrating one example of a procedure of representative speed calculation processing;

FIG. 13 is a flowchart illustrating one example of a procedure of degree-of-risk offering processing;

FIG. 14 is a diagram illustrating en example in which a degree of risk according to speed of an automobile is used for safe driving management;

FIG. 15 is a diagram illustrating an example in which a degree of risk according to speed of an automobile is used for motivation for safe driving by a discount of an insurance premium of automobile insurance; and

FIG. 16 is a flowchart illustrating one example of a procedure of representative speed transmission processing.

### DESCRIPTION OF EMBODIMENTS

The risk according to the speed of a moving object greatly depends on the present situation around the moving object. For this reason, if the risk is determined with the maximum speed and average speed of the moving object in a certain period, the present situation around the moving object is not considered and the accuracy is insufficient. For example, when the case in which an automobile moves at 80 km/hour on an expressway and the case in which the automobile moves at 70 km/hour on an urban road are compared, the risk is higher in the latter case although the speed is higher in the former case. Furthermore, even when an automobile travels on a specific road, the risk is higher when the automobile travels at 60 km/hour on a rainy or snowy day than when the automobile travels at 60 km/hour on a sunny day, and determining that the risk is the same ends in an incorrect determination result.

However, in the past, a measure to take into consideration the present situation of a moving object and properly determine the risk according to the speed f the moving object does not exist Thus, the determination accuracy of the risk according to the speed of the moving object is insufficient.

Embodiments will be described below with reference to the drawings. Each embodiment may be carried out by combining plural embodiments within a range in which contradiction is not caused.

### First Embodiment

First, a first embodiment will be described.

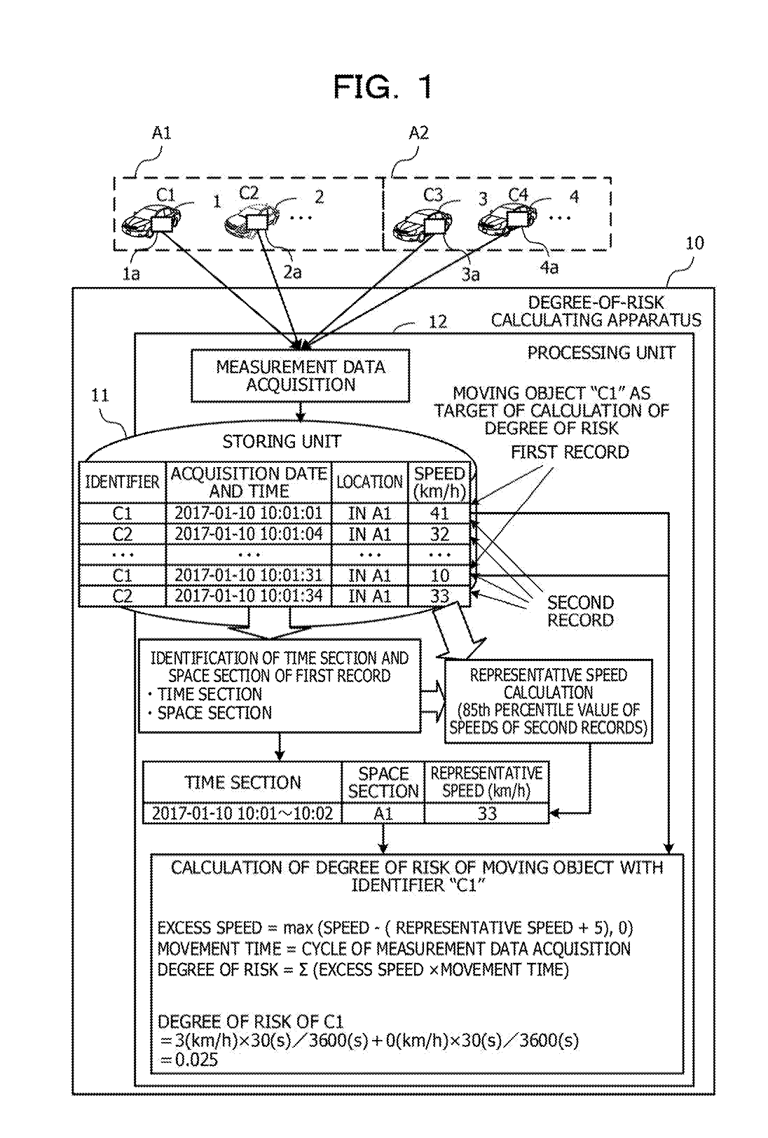

FIG. 1 is a diagram illustrating one example of a degree-of-risk calculating apparatus according to the first embodiment. A degree-of-risk calculating apparatus 10 includes a storing unit 11 and a processing unit 12. The storing unit 11 is a memory or a storage apparatus the degree-of-risk calculating apparatus 10 includes, for example. The processing unit 12 is a processor or arithmetic circuit the degree-of-risk calculating apparatus 10 includes, for example.

The storing unit 11 stores the location and speed on different dates and times regarding each of plural moving objects 1, 2, 3, 4, . . . . The plural moving objects 1, 2, 3, 4, . . . are automobiles, for example. Identifiers “C1” “C2,” “C3,” “C4,” are given to the plural moving objects 1, 2, 3, 4, respectively. The plural moving objects 1, 2, 3, 4, . . . are equipped with measurement equipment 1a, 2a, 3a, 4a, . . . , respectively. Each of the plural pieces of measurement equipment 1a, 2a, 3a, 4a, . . . periodically measures the location and speed of each of the moving object 1, 2, 3, 4, . . . equipped with each of the measurement equipment 1a, 2a, 3a, 4a, . . . and transmits measurement data that represents the measurement result to the degree-of-risk calculating apparatus 10.

The processing unit 12 acquires the measurement data that represents the location and speed of the moving objects 1, 2, 3, 4, . . . equipped with the measurement equipment 1a, 2a, 3a, 4a, . . . from the measurement equipment 1a, 2a, 3a, 4a, . . . , with which a respective one of the plural moving objects 1, 2, 3, 4, . . . is equipped. Then, the processing unit 12 stores, in the storing unit 11, records including the clock times when the pieces of measurement data have been acquired, the identifiers of the moving objects 1, 2, 3, 4, . . . , and the pieces of measurement data. The acquisition of the measurement data from each of the pieces of measurement equipment, 1a, 2a, 3a, 4a. . . is periodically carried out, for example. As a result, the plural records are stored in the storing unit 11.

Thereafter, the processing unit 12 identifies a first record that includes information with which a target moving object as a target of calculation of the degree of risk may be identified and whose measurement data represents a clock time in a target time section and a location in a target space section from the plural records stored in the storing unit 11. The information with which the target moving object may be identified is the identifier of the target moving object, for example. Furthermore, it is also possible, to use the identifier of the measurement equipment with which the target moving object is equipped as the information with which the target moving object may be identified, for example.

For example, the processing unit 12 extracts the first record in response to a request for acquisition of the degree of risk with specifying of the identifier of the target moving object. The time section including the acquisition clock time represented in the extracted first record among plural time sections obtained by dividing the acquisition period of the measurement data is the target time section. Furthermore, the space section including the location represented in the extracted first record in plural space sections A1 and A2 obtained by dividing the movement space of the plural moving objects 1, 2, 3, 4, . . . is the target space section.

Next, the processing unit 2 extracts one or more second records that represent a clock time in the target time section and a location in the target space section from the plural records in the storing unit 11. The above-described first record may be included in the second records. In this case, records other than the first record are also included as the second records. The processing unit 12 calculates the degree of risk of the target moving object based on the difference between a representative speed that is a representative value of the speeds represented in plural second records and the speed represented in the first record. The representative speed is the N-th percentile value (N is a real number in a range of 0 to 100 inclusive) of the speed represented in a respective one of the plural second records, for example. The processing unit 12 outputs the calculated degree of risk.

According to such a degree-of-risk calculating apparatus 10, the degree of risk of the target moving object as the target of calculation of the degree of risk may be calculated with high accuracy. For example, the present situation around the target moving object as the target of calculation of the degree of risk is reflected in the representative speed based on the measurement data of the moving objects that exist in the same space section as the target moving object in the same time section as the clock time at which the location and speed of the target moving object have been measured. For this reason, by calculating the degree of risk based on the difference between the speed of the target moving object and the representative speed, the degree of risk according to the speed of the target moving object is calculated also in consideration of the present situation around the target moving object. As a result, the accuracy of the degree of risk is improved.

For example, when the target moving object is traveling on an expressway, other moving objects that exist in the same space section as the target moving object are also traveling on the expressway in the time section including the clock time at which measurement data has been acquired from the target moving object. In this case, the representative speed is a high value such s 100 km/hour. In this case, even when the target moving object i traveling at 80 km/hour, the calculated degree of risk is a low value and it is indicated that this traveling is safe traveling by the numerical value of the degree of risk. On the other hand, when the target moving object is traveling on a road in an urban area, other moving objects that exist in the same space section as the target moving object are also traveling on the road in the urban area in the time section including the clock time at which measurement data has been acquired from the target moving object. In this case, the representative speed is a low value such as 40 km/hour. At this time, if the target moving object is traveling at 60 km/hour, the degree of risk is a high value and it is indicated that this traveling is dangerous traveling by the numerical value. As above, because the present situation around the target moving object is reflected in the representative speed, the degree of risk according to the speed of the target moving object may be calculated also in consideration of the present situation around the target moving object. As a result, the accuracy of the degree of risk is improved.

Similarly, in the case in which the target moving object is an automobile and the automobile travels on a road, even though the representative speed is 60 km/hour on a sunny day, the representative speed is a low value such as 20 km/hour when the automobile travels on the same road on a snowy day. As above, due to the reflection of the present situation around the target moving object in the representative speed, the degree of risk according to the speed of the moving object may be accurately calculated.

The processing unit 12 may calculate the degree of risk in consideration of the time for which the target moving object has traveled at a dangerous speed. For example, the processing unit 12 calculates an excess speed based on the difference between the speed represented in the first record and the representative speed. The excess speed is the result of subtraction of the value obtained by adding an allowable error to the representative speed from the speed represented in the first record, for example. In the example of FIG. 1, the allowable error of the representative speed is “5 km/hour.”

Next, the processing unit 12 calculates the degree of risk based en the result of multiplication of the excess speed by the movement time of the target moving object at the speed represented in the first record. The movement time of the target moving object at the speed represented in the first record is the elapsed time from the acquisition clock time of the first record to the clock time at which the next record as the first record is acquired from the measurement equipment of the target moving object, for example. If the acquisition cycle of measurement data is settled in advance, the acquisition cycle may be employed as the movement time of the target moving object at the speed represented in the first record. Suppose that measurement data is acquired at a cycle of 30 seconds in the example of FIG. 1.

Furthermore, if plural first records including the identifier of the target moving object exist, the processing unit 12 may employ the total of numerical values obtained from a respective one of the plural first records as the degree of risk. For example, if plural fast records exist, the processing, unit 12 calculates the excess speed regarding each first record and obtains the result of multiplication of the excess speed by the movement time of the target moving object at the speed represented in the first record. Then, the processing unit 12 employs the total of the multiplication results of the plural first records as the degree of risk of the target moving object.

For example, suppose that the moving object 1 with the identifier “C1” is the target moving object as the target of calculation of the degree of risk. Suppose that the time width of each time section is one minute. In this case, the processing unit 12 identifies records with the identifier “C1” among the records stored in the storing unit 11 as the first records. In the example of FIG. 1, two first records exist. Next, the processing unit 12 employs, as the target me section, a time section “2017-01-10 10:01 to 10:02” including “2017-01-10 10:01:01” and “2017-01-10 10:01:31” as the dates and times (dates and clock tunes) when measurement data in the first record has been acquired. Furthermore, the processing unit 12 employs the space section A1 including the locations represented in the first records as the target space section. Next, the processing unit 12 acquires, from the storing unit 11, records that each, include an acquisition clock time in the target time section “2017-01-10 10:01 to 10:02” and each represent a location in the space section A1 as the target space section, and employs the acquired records as the second records. Then, the processing unit 12 calculates the representative value (for example, 85th percentile value) of the speeds of the second records and employs the representative value as the representative speed. Suppose that the representative speed is “33 km/hour” in the example of FIG. 1.

The processing unit 12 calculates the degree of risk of the moving object 1 as the target moving object based on the representative speed “33 km/hour” and the speeds “41 km/hour” and “10 km/hour” represented in the first records. For example, the processing unit 12 subtracts the value obtained by adding the allowable error “5 km/hour” to the representative speed “33 km/hour” (38 km/hour) from the speed “41 km/hour” represented in the earlier first record to obtain an excess speed “3 km/hour” corresponding to the earlier first record. Similarly, the processing unit 12 subtracts “38 km/hour” from the speed “10 km/hour” represented in the later first record. The processing unit 12 sets the excess speed to “0 km/hour” if the subtraction result is a negative value.

In the example of FIG. 1, the movement time of the moving object 1 at the speed represented in a respective one of the first records is 30 seconds. The processing unit 12 multiplies the excess speed obtained regarding each first record by the movement time and employs the value obtained by summing up the multiplication results as the degree of risk. In the example of FIG. 1, 0.025 is calculated as the degree of risk.

The degree of risk obtained in this manner becomes a value larger than 0 when the speed of the moving object 1 as the target moving object is high compared with the speeds of a large number of moving objects in the same situation as the present situation around the moving object 1, and the value of the degree of risk becomes larger when the speed of the moving object 1 is higher. Due to this, for example, when the moving object 1 is an automobile, the degree of risk is higher when the moving object 1 moves at 70 km/hour on an urban road than when the moving object 1 moves at 80 km/hour on an expressway. Furthermore, the degree of risk is higher when the moving object 1 travels at 60 km/hour on a rainy or snowy day than when the moving object 1 travels at 60 km/hour on a sunny day. As above, the accurate degree of risk is calculated.

In addition, by calculating the degree of risk also in consideration of the movement time at a speed with high risk, the value of the degree of risk becomes larger when the time for which the moving object 1 as the target moving object has, moved at the dangerous speed is longer. For example, if the moving object 1 as the target moving object is an automobile, the possibility that an accident is caused becomes higher when the time for which the moving object 1 travels at a dangerous speed is longer. Therefore, the calculation accuracy of the degree of risk is further improved by carrying out the calculation in such a manner that the degree of risk becomes higher when the time for which the target moving object has moved at a dangerous speed is longer.

The representative speed may be calculated after the target moving object as the target of calculation of the degree of risk is decided or may be calculated in advance. If the representative speed is calculated in advance, the processing unit 12 generates plural time-space sections each obtained by combining one of plural time sections and one of plural space sections. Next, the processing unit 12 classifies each of plural records into any of the time-space sections based on the clock time and the location, and calculates the representative speed based on the speed represented in a respective one of the plural classified records classified into the time-space sections regarding each time-space section. Subsequently, the processing unit 12 stores the representative speed of each time-space section in the storing unit 11. Thereafter, in response to input to specify the target moving object, the processing unit 12 acquires the representative speed of the target time-space section corresponding to the set of the target time section and the target space section from the storing unit 11. Then, the processing unit 12 calculates the degree of risk of the target moving object based on the difference between the acquired representative speed and the speed represented in the first record. As above, by calculating the representative speed of each time-space section in advance, the degree of risk may be rapidly returned in response to a request for acquisition of the degree of risk in the case of calculating the degree of risk in response to the request for acquisition of the degree of risk, for example.

Furthermore, it is also possible for the processing unit 12 to transmit the calculated representative speed to the respective moving objects 1, 2, 3, 4, . . . . For example, when acquiring one piece of measurement data from one piece of measurement equipment, the processing unit 12 identifies the immediately-recent time section corresponding to an immediately-recent period among plural time sections. Next, the processing unit 12 identifies the present location space section including the location represented in the one piece of measurement data among plural space sections and transmits the representative speed of the present time-space section corresponding to the set of the immediately-recent time section and the present location space section to the one piece of measurement equipment. By transmitting the representative speed in which the present situation around a respective one of the moving objects 1, 2, 3, 4, . . . is reflected to each of the moving objects 1, 2, 3, 4, . . . as above, the representative speed may be utilized for safe operation of the moving objects 1, 2, 3, 4, . . . . For example, if the moving objects 1, 2, 3, 4, . . . are automobiles in automatic driving, the automobiles may be each made to travel at a safe speed according to the present situation around the automobile if speed control according to the representative speed transmitted to the moving objects 1, 2, 3, 4, . . . is carried out.

### Second Embodiment

Next, a second embodiment will be described,

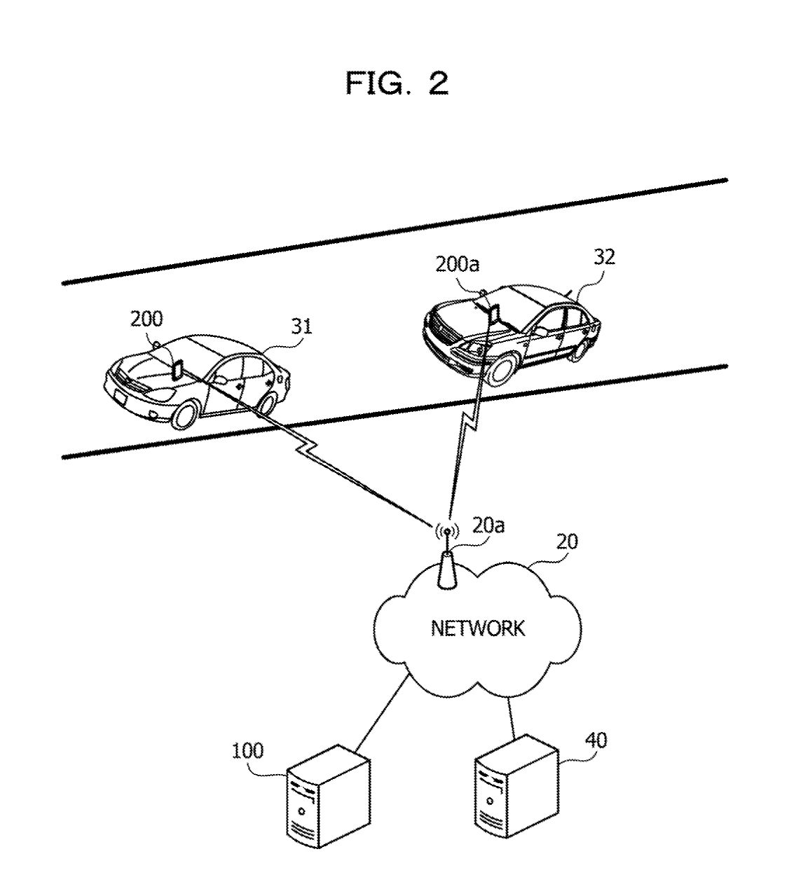

FIG. 2 is a diagram illustrating a system configuration example of the second embodiment. The respective automobiles 31 and 32 are equipped with pieces of in-car equipment 200 and 200a. The pieces of in-car equipment 200 and 200a are each a car navigation system or a mobile terminal apparatus such as a smartphone. The pieces of in-car equipment 200 and 200a each measure traveling data of the corresponding automobile 31 or 32. The traveling data of each of the automobiles 31 and 32 is data including the location and speed of the automobile 31 or 32. The pieces of in-car equipment 200 and 200a may be coupled to a network 20 by a radio measure. A vehicle speed management server 100 and an information using server 40 are coupled to the network 20. Furthermore, the pieces of in-car equipment 200 and 200a transmit the traveling data given the identifier of the automobile (automobile ID) and date and time to the vehicle speed management server 100.

The vehicle speed management server 100 is a computer that calculates the degree of risk of the automobile as the target of calculation of the degree of risk based on the traveling data of the respective automobiles 31 and 32. For example, the vehicle speed management server 100 periodically acquires information on the location and speed of the, automobiles 31 and 32 from the pieces of in-car equipment 200 and 200a of the respective automobiles 31 and 32. Furthermore, regarding each area and each time zone, the vehicle speed management server 100 calculates the representative speed of automobiles that have traveled in the area based on the vehicle speed of the respective automobiles 31 and 32. The representative speed is a statistical representative value of the speed of automobiles that have passed through a specific place in a specific time zone. As the representative speed, the 85th percentile speed of automobiles that have passed through a specific place in a specific time zone may be used, for example. The 85th percentile speed is the speed of the automobile corresponding to the 85th percentile when automobiles are counted from the automobile with the lowest speed in the speed distribution of all automobiles. Then, the vehicle speed management server 100 calculates the degree of risk of the automobile as the target of calculation of the degree of risk based on the difference between the calculated representative speed and the speed of the automobile 31 or 32.

The information using server 40 is a computer used by a provider of a service with use of the degree of risk of the automobiles 31 and 32. The information using server 40 acquires information on the degree of risk of the automobiles 31 and 32 from the vehicle speed management server 100 and stores the information in a storage apparatus. Then, the information using server 40 uses the degree of risk of the automobiles 31 and 32 for service provision. For example, if the information using server 40 is set in an insurance company that deals with automobile insurances, the information using server 40 calculates the insurance premium of a policyholder based on the degree of risk of the automobile used by the policyholder. In this case, a lower insurance premium is figured out for the policyholder with a lower degree of risk of the automobile used.

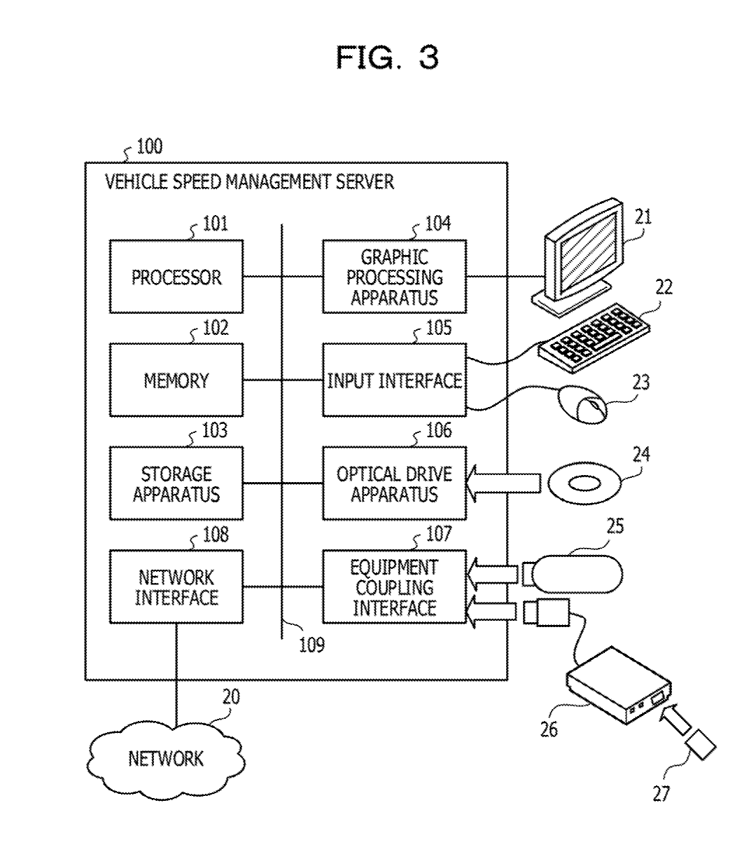

FIG. 3 is a diagram illustrating one configuration example of hardware of a vehicle speed management server used for the second embodiment. The whole apparatus of the vehicle speed management server 100 is controlled by a processor 101. A memory 102 and plural pieces of peripheral equipment are coupled to the processor 101 through a bus 109. The processor 101 may be a multiprocessor. The processor 101 is a central processing unit (CPU), a micro processing unit (MPU), or a digital signal processor (DSP), for example. At least part of functions implemented through execution of a program by the processor 101 may be implemented by an electronic circuit such as an application specific integrated circuit (ASIC) or a programmable logic device (PLD).

The memory 102 is used as, a main storing apparatus of the vehicle speed management server 100. In the memory 102 at least part of a program of an operating system (OS) or an application program the processor 101 is caused to execute is temporarily stored. Furthermore, various kinds of data used for processing by the processor 101 are stored in the memory 102. As the memory 102, a volatile semiconductor storing apparatus such as a random access memory (RAM) is used.

As the pieces of peripheral equipment coupled to the bus 109, a storage apparatus 103, a graphic processing apparatus 104, an input interface 105, an optical drive apparatus 106, an equipment coupling interface 107, and a network interface 108 exist.

The storage apparatus 103 writes and reads data to and from a built-in recording medium electrically or magnetically. The storage apparatus 103 is used as an auxiliary storing apparatus of the computer. The program o the OS, application programs, and various kinds, of data are stored in the storage apparatus 103. As the storage apparatus 103, hard disk drive (HDD) and solid state drive (SSD) may be used, for example.

A monitor 21 is coupled to the graphic processing apparatus 104. The graphic processing apparatus 104 causes an image to be displayed on the screen of the monitor 21 in accordance with a command from the processor 10L As the monitor 21, a display apparatus using a cathode ray tube (CRT), a liquid crystal display apparatus, and so forth exist.

A keyboard 22 and a mouse 23 are coupled to the input interface 105. The input interface 105 transmits signals sent from the keyboard 22 and the mouse 23 to the processor 101. The mouse 23 is one example of a pointing device and it is also possible to use other pointing devices. As other pointing devices, touch panel, tablet, touchpad, trackball, and so forth exist.

The optical drive apparatus 106 reads data recorded on an optical disc 24 by using laser light or the like. The optical disc 24 is a portable recording medium on which data is, recorded in such a manner as to be readable by reflection, of light. As the optical disc 24, digital versatile disc (END) DVD-RAM, compact disc read-only memory (CD-ROM), CD-recordable (R)/rewritable (RW), and so forth exist.

The equipment coupling interface 107 is a communication interface for coupling pieces of peripheral equipment to the vehicle speed management server 100. A memory apparatus 25 and a memory reader-writer 26 may be coupled to the equipment coupling interface 107, for example. The memory apparatus 25 is a recording medium equipped with a function of communication with the equipment coupling interface 107. The memory reader-writer 26 is an apparatus that writes data to a memory card 27 or reads out data from the memory card 27. The memory card 27 is a card-type recording medium.

The network interface 108 is coupled to the network 20. The network interface 108 carries out transmission and reception of data with other computers or pieces of communication equipment through the network 20.

The processing functions in the vehicle speed management server 100 may be implemented by the hardware configuration described above. The information using server 40 may also be implemented by the like hardware as the vehicle speed management server 100. Furthermore, the degree-of-risk calculating apparatus 10 represented in the first embodiment may also be implemented by the like hardware as the vehicle speed management server 100 illustrated in FIG. 3.

The vehicle speed management server 100 implements the processing functions of the second embodiment by executing a program recorded on a computer-readable recording medium, for example. The program in which the contents of processing to be executed by the vehicle speed management server 100 is described may be recorded in various recording media. For example, the program to be executed by the vehicle speed management server 100 may be stored in the storage apparatus 103. The processor 101 loads at least part of the program in the storage apparatus 103 into the memory 102 and executes the program. Furthermore, it is also possible to record the program to be executed by the vehicle speed management server 100 on a portable recording medium such as the optical disc 24, the memory apparatus 25, or the memory card 27. The program stored in the portable recording medium becomes executable after being installed on the storage apparatus 103 based on control from the processor 101, for example. Moreover, it is also possible for the processor 101 to directly read out the program from the portable recording medium and execute the program.

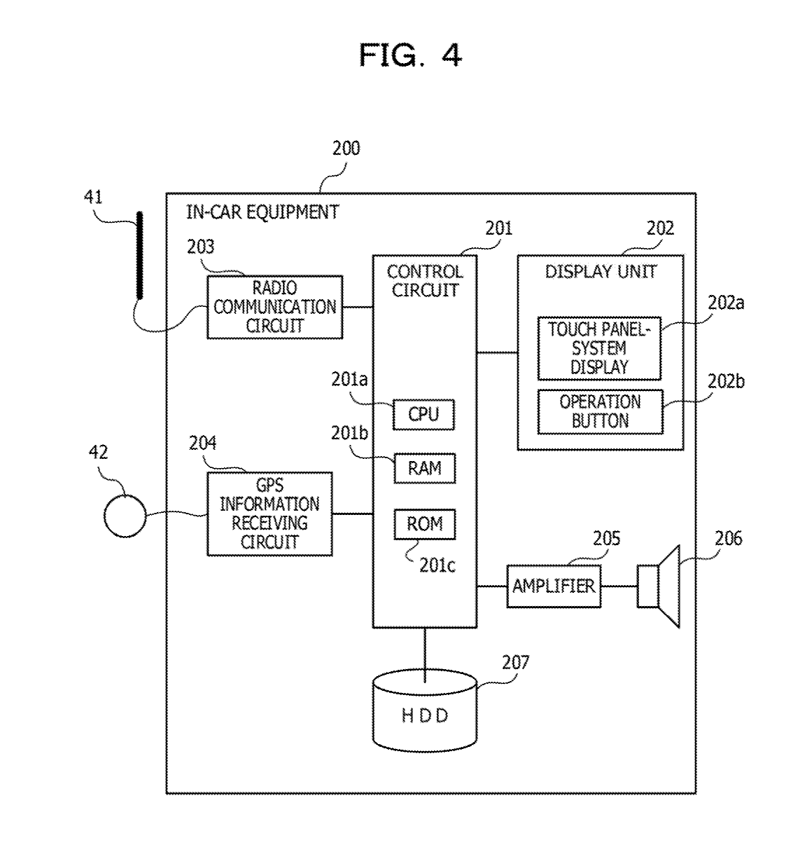

FIG. 4 is a diagram illustrating one configuration example of hardware of in-car equipment. The in-car equipment 200 has functions as a car navigation system. The in-car equipment 200 includes a control circuit 201, a display unit 202, a radio communication circuit 203, a global positioning system (GPS) information receiving circuit 204, an amplifier 205, a speaker 206, and an HDD 207.

The control circuit 201 controls the whole of the in-car equipment 200. The control circuit 201 includes a CPU 201a, a RAM 201b, and a ROM 201c. The ROM 201c is a non-volatile, recitable, high-capacity storage medium such as a flash memory and stores various kinds of programs and various kinds of data. Furthermore, the RAM 201b temporarily stores programs executed by the CPU 201a and pieces of data used for execution of the programs. The CPU 201a reads out the respective programs and the respective pieces of data from the ROM 201c to execute processing in accordance with these programs.

The display unit 202 displays image data sent from the control circuit 201. The display unit 202 includes a touch panel-system display 202a and operation buttons 202b. The touch panel-system display 202a is a liquid crystal display apparatus in which a touch panel is set on a surface, for example. The display unit 202 displays an image based on the image data sent from the control circuit 201 on the touch panel-system display 202a. Furthermore, when the touch panel of the touch panel-system display 202a is pressed, the display unit 202 outputs information that represents the pressed position to the control circuit 201. Moreover, when the operation button 202b is pressed, the display unit 202 transmits a signal corresponding to the pressed operation button to the control circuit 201.

The radio communication circuit 203 is coupled to a communication antenna 41. The radio communication circuit 203 transmits information output from the control circuit 201 to a base station 20a through the communication antenna 41 by radio communication. Furthermore, the radio communication circuit 203 receives information transmitted from the base station 20a to the in-car equipment 200 through the communication antenna 41 and outputs the information to the control circuit 201.

The GPS information receiving circuit 204 is coupled to a GPS antenna 42. The GPS information receiving circuit 204 receives signals of radio waves from GPS satellites through the GPS antenna 42. The GPS information receiving circuit 204 outputs the received signal to the control circuit 201. The GPS is a system with which positioning of the location of the automobile is carried out based on radio waves from at least three satellites among a large number of GPS satellites that revolve around the Earth. The control circuit 201 analyzes signals of radio waves of plural GPS satellites and determines the present location of the automobile 31

The amplifier 205 is coupled to the speaker 206. The amplifier. 205 amplifies a sound signal sent from the control circuit 201 and outputs the sound signal to the speaker 206.

The HDD 207 stores various kinds of data such as map data. The control circuit 201 determines the route to the destination based on the map data stored in the HDD 207.

The pieces of measurement equipment 1a, 2a, 3a, and 4a illustrated in the first embodiment may also be implemented by the like hardware as the in-car equipment 200 of FIG. 4.

The processing functions of the vehicle speed management server 100 and the in-car equipment 200 may be implemented by the hardware configuration described above.

Next, functions the vehicle speed management server 100 has in order to calculate the degree of risk will be described.

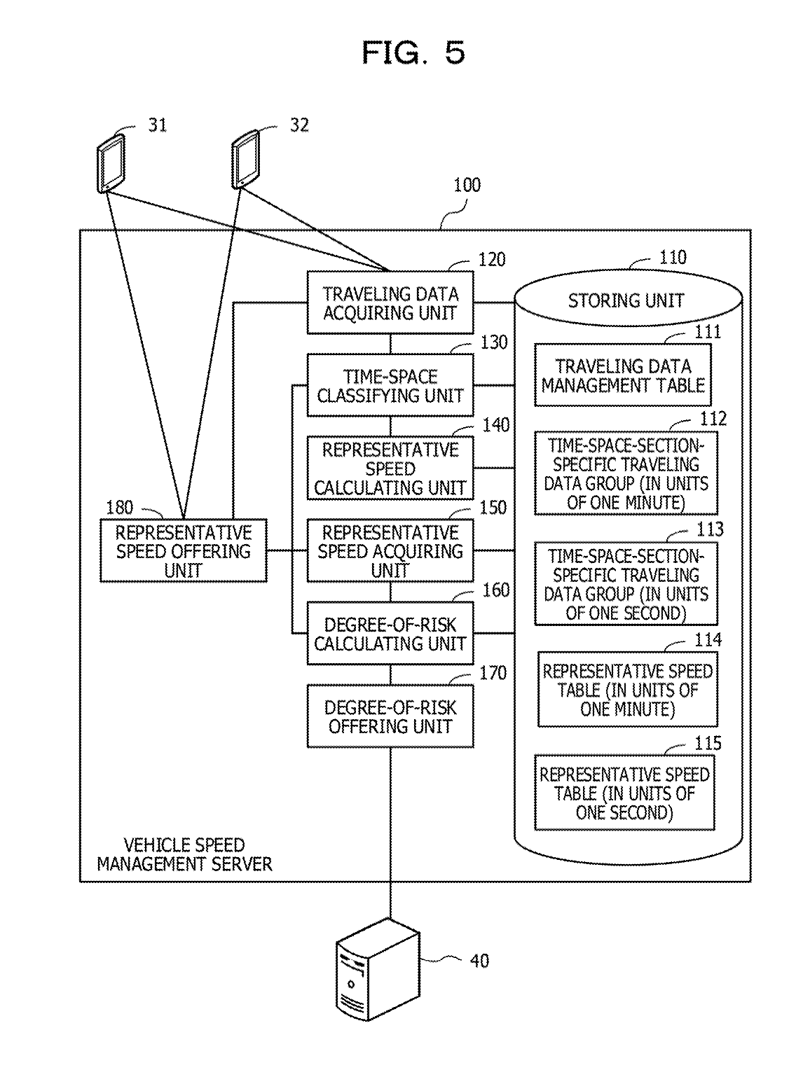

FIG. 5 is a block diagram illustrating functions of a vehicle speed management server. The vehicle speed management server 100 includes a storing unit 110, a traveling data acquiring unit 120, a time-space classifying unit 130, a representative speed calculating unit 140, a representative speed acquiring unit 150, a degree-of-risk calculating unit 160, a degree-of-risk offering unit 170, and a representative speed offering unit 180.

The storing unit 110 stores a traveling data management table 111, time-space-section-specific traveling data groups 112 and 113, and representative speed tables 114 and 115. The traveling data management table 111 is a data table in which pieces of traveling data of the automobiles 31 and 32 periodically collected from the respective pieces of in-car equipment 200 and 200a are registered. The time-space-section-specific traveling data groups 112 and 113 are what are obtained by classifying records in the traveling data management table 111 according to the time zone and the space (place), n the example of FIG. 5, the time-space-section-specific traveling data group 112 in which records are classified based on the time zones in units of one minute and the time-space-section-specific traveling data group 113 in which records are classified based on the time zones in units of one second are stored in the storing unit 110. The representative speed tables 114 and 115 are data tables in which records that each represent the representative speed in the relevant time zone in the relevant space regarding a respective one of the sets of the time zone and the space are registered. In the example of FIG. 5, the representative speed table 114 in which the representative speed obtained regarding each time zone in units of one minute is registered and the representative speed table 115 in which the representative speed obtained regarding each time zone in units of one second is registered are stored in the storing unit 110.

The traveling data acquiring unit 120 continuously acquires the traveling data from each automobile. For example, the traveling data acquiring unit 120 acquires the traveling data from the pieces of in-car equipment 200 and 200a of the plural automobiles 31 and 32 about which an agreement on the acquisition has been made in advance through radio communication or the like. The traveling data acquiring unit 120 stores records of the acquired traveling data in the traveling data management table 111 in the storing unit 110.

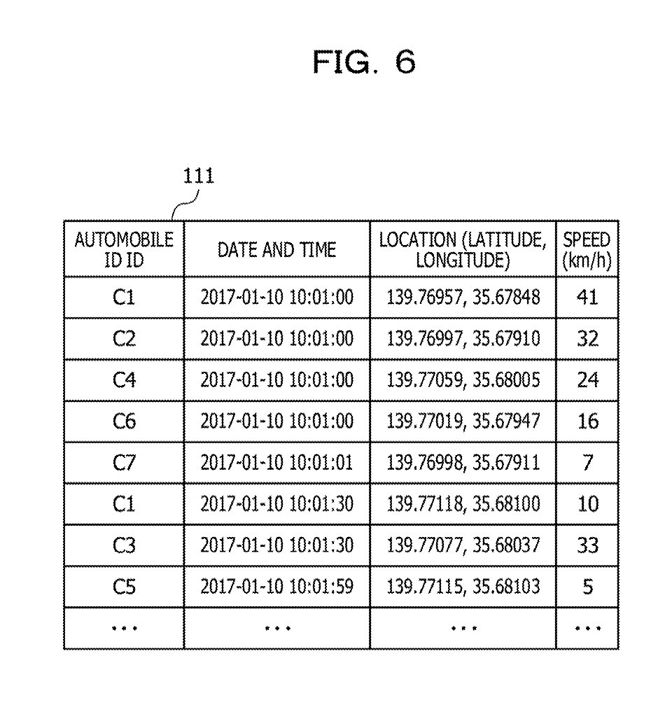

FIG. 6 is a diagram illustrating one example of a traveling data management table. In the traveling data management table 111, fields of automobile ID, date and time, location, and speed are set. In the field of the automobile ID, the identifier (automobile ID) of the automobile with which the in-car equipment of the acquisition source of the traveling data is equipped is set. In the field of the date and time, the date and time when the traveling data has been acquired is set. In the field of the location, the location of the automobile represented by the automobile ID is set. The location is represented by the latitude and longitude, for example. In the field of the speed, the speed of the automobile represented by the automobile ID is set

In the example of FIG. 6, an example of travelling data in one minute from 10:01 on Jan. 10, 2017 is represented in the traveling data management table 111. In the example of FIG. 6, the traveling data of an automobile with an automobile ID “C1” has been acquired twice in the one minute and pieces of the traveling data of automobiles with automobile IDs “C2” to “C7” have been each, acquired one time in the one minute. The date and time is represented on the second time scale. As the location, the latitude and longitude are represented in increments of 10⁻⁵ degrees. The speed is represented in increments of 1 km/hour.

Regarding the location, the traveling data may include altitude data. Furthermore, the information on the location may be information on the identifier of a road (road ID) and a location on the road (distance from an end). For example, in some cases, processing of identifying the road area is executed in a car navigation system or the like the piece of in-car equipment 200 and 200a include. In this case, the traveling data acquiring unit 120 acquires traveling data including a road ID as the information on the, location from the pieces of in-car equipment 200 and 200a.

The traveling data acquiring unit 120 may delete, as needed, a record that will not be used in the future among the pieces of traveling data recorded in the traveling data management table 111.

In the following, explanation of FIG. 5 will be made again.

The time-space classifying unit 130 classifies the records registered as the traveling data into combinations of the time section and the space section (time-space sections). For example, the time-space classifying unit 130 divides the period in which pieces of traveling data have been acquired into time zones at intervals of one minute or at intervals of one second and deems each time zone as the time section. The time-space classifying unit 130 implements the classification into the time sections whose time,intervals are one minute by rounding the date and time represented in the traveling data down to the minute, for example.

The time-space classifying unit 130 employs the area of each road in a road map as the space section. The space section is represented by the road ID of the corresponding road, for example. Information relating to the area of each road (range of latitude and longitude) may be acquired from map information opened to the public. The time-space classifying unit 130 implements classification of records of traveling data into the space sections by converting the location to the road ID of the road area corresponding to the location by map matching or the like.

When discriminating the time-space section of a record in the traveling data, the time-space classifying unit 130 registers the record in the time-space-section-specific traveling data groups 112 and 113 corresponding to the time-space section.

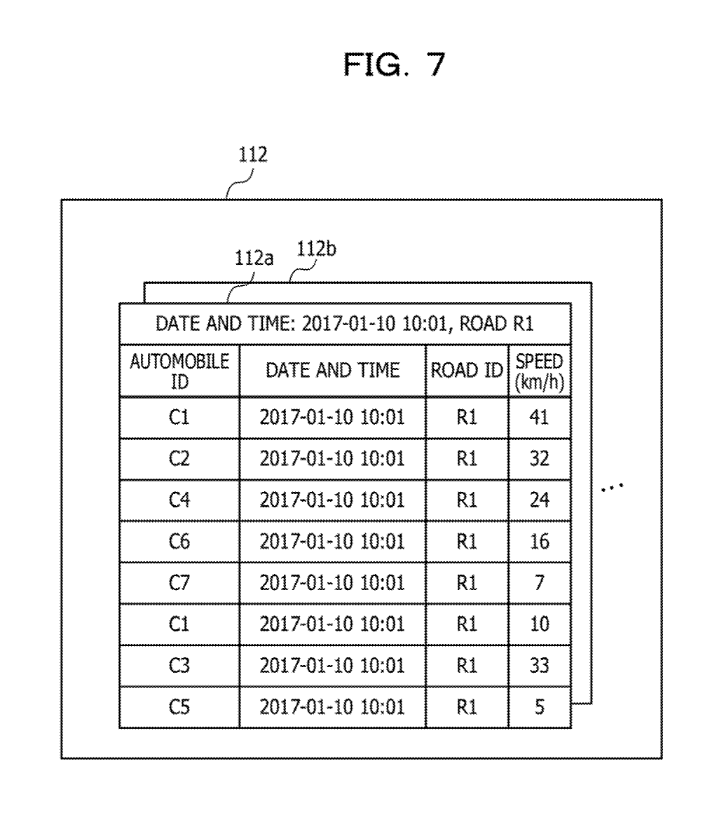

FIG. 7 is a diagram illustrating one example of a time-space-section-specific traveling data group in units of one minute. In the time-space-section-specific traveling data group 112 in units of one minute, time-space traveling data tables 112a, 112b, . . . of each time-space section are included. For example, the time-space traveling data table 112a corresponds to a set of a time section of one minute from date and time “10:01 on Jan. 10, 2017” and a space section of a road ID “R1.” Fields of automobile ID, date and time, road ID and speed are set in each of the time-space traveling data tables 112a, 112b, . . . . In the field of the automobile ID, the automobile ID of the automobile with which the in-car equipment of the acquisition source of the traveling data is equipped is set. In the field of the date and time, the acquisition date and time of the traveling data is set. In the time-space traveling data tables 112a, 112b, . . . in units of one minute, the date and time of each record is rounded down to the minute. In the field of the road ID, the road ID of the road corresponding to the locations represented in the respective pieces of traveling data is set. In the field of the speed, the speeds represented in the respective pieces of traveling data are set. The date and time and the road ID of each record registered in one time -space traveling data table are common. For example, the dates and times of the respective records of the time-space traveling data table 112a are all “2017-01-10 10:01” and the road IDs are all “R1,”

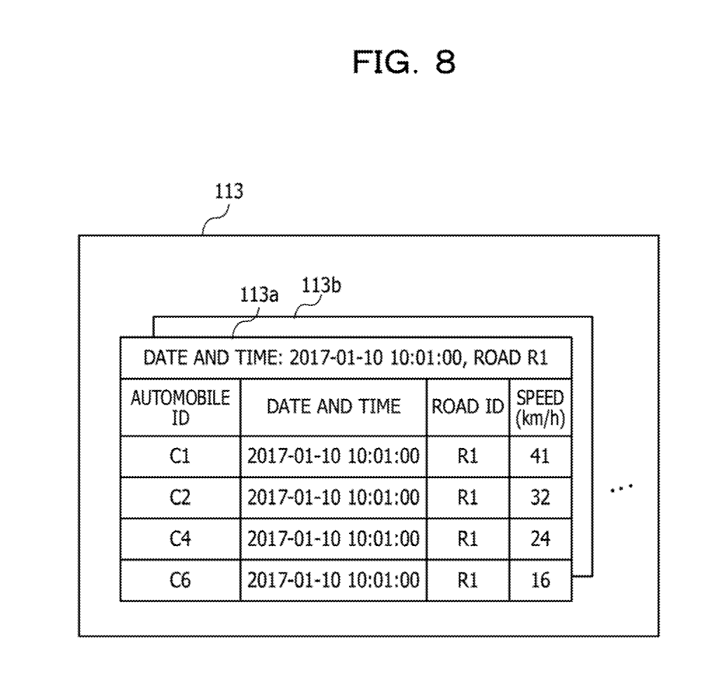

FIG. 8 is a diagram illustrating one example of a time-space-section-specific traveling data group in units of one second. In the time-space-section-specific traveling data group 113 in units of one second, time-space traveling data tables 113a, 113b, . . . of each time-space section are included. For example, the time-space traveling data table 113a corresponds to a set of a time section of one second from date and time “10:01:00 on Jan. 10, 2017” and the space section of the road ID “R1,” The same type of information as the time-space traveling data tables 112a, 112b, . . . represented in FIG. 7 is registered in the time-space traveling data tables 113a, 113b, . . . except for that the date and time is on the second time scale.

In the following, explanation of FIG. 5 will be made again.

The representative speed calculating unit 140 figures out the representative speed from the speed distribution of classified traveling data. As the representative speed, a statistic that represents the speed when automobiles actually travel on a road (actual operating speed) is used. For example, the representative speed calculating unit 140 uses the 85th percentile speed as the representative speed. The 85th percentile speed is a statistic used in many organizations as the actual operating speed. Suppose that, if plural records of the same automobile exist in the same time-space section, the representative speed calculating unit 140 uses only the record with the maximum speed among the records of the same automobile as an element of the speed distribution. For example, the representative speed of the time-space section regarding which the time section is one minute from “10:01 on Jan. 10, 2017” and the space section is “R1” is calculated as follows based on the corresponding time-space traveling data table 112a (see FIG. 4

In the time-space traveling data table 112a, two records exist as traveling data of an automobile with an automobile ID “C1.” The speed of one record is “41 km/hour” and the speed of the other record is “10 km/hour.” In this case, the speed represented in the record with the speed that is not the highest value (10 km/hour) is not used as an element of the speed distribution. Thus, the speeds in the speed distribution in increasing order are [5, 7, 16, 24, 32, 33, 41]. In this case, the 85th percentile speed as the representative speed is about “33 km/hour.”

The representative speed calculating unit 140 stores the representative speeds calculated from each of the time-space-section-specific traveling data groups 112 and 113 in the representative speed tables 114 and 115.

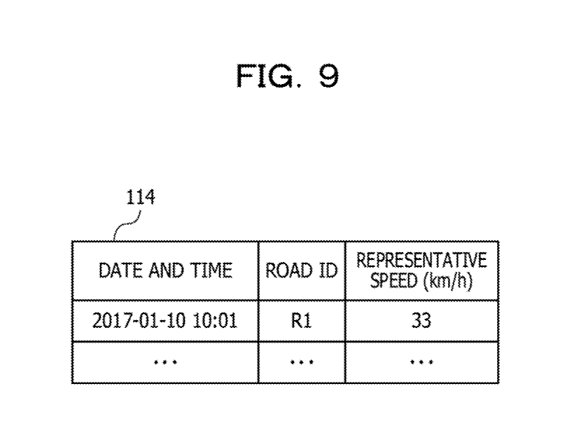

FIG. 9 is a diagram illustrating one example of a representative speed table in units of one minute. In the representative speed table 114 in units of one minute, fields of date and time, road ID, and representative speed are set. In the field of the date and time, the date and time that represents the time section of the time-space section is set In the field of the road ID, the road ID that represents the space section of the time-space section is set In the field of the representative speed, the representative speed is registered in association with the set of the date and time and the road ID that represent the time-space section. The representative speed calculating unit 140 may delete a record that will not be used in the future as needed.

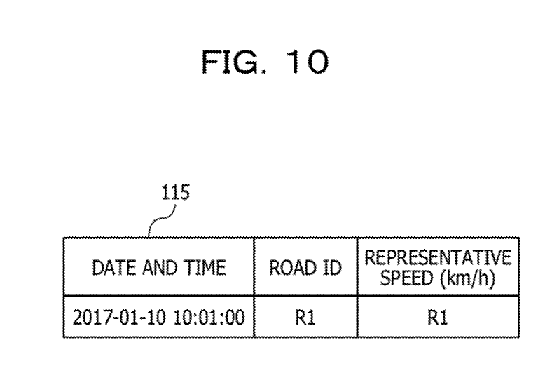

FIG. 10 is a diagram illustrating one example of a representative speed table in units of one second. The same type of information as the representative speed table 114 in units of one minute is registered in the representative speed table 115 in units of one second except for that the date and time is on the second time scale.

In the following, explanation of FIG. 5 will be made again.

In response to input to specify a time-space section, the representative speed acquiring unit 150 acquires the, representative speed corresponding to the time-space section from the representative speed table and outputs the representative speed. For example, if input to specify a time-space section is made from the degree-of-risk calculating unit 160, the representative speed acquiring unit 150 retrieves the specified time-space section from the representative speed table 114, in which the time interval is one minute, and outputs the representative speed corresponding to the relevant time-space section to the degree-of-risk calculating unit 160. Furthermore, if input to specify a time-space section is made from the representative speed offering unit, 180, the representative speed acquiring unit 150 retrieves the specified time-space section from the representative speed table 115, in which the time interval is one second, and outputs the representative speed corresponding to the relevant time-space section to the representative speed offering unit 180.

When an automobile ID is input from the degree-of-risk offering unit 170 to the degree-of-risk calculating unit 160, the degree-of-risk calculating unit 160 calculates the degree of risk of the corresponding automobile based on traveling data of the automobile. For example, when an automobile ID is input from the degree-of-risk offering unit 170, the degree-of-risk calculating unit 160 acquires a record that represents traveling data of the corresponding automobile from the traveling data management table 111. Next, the degree-of-risk calculating unit 160 specifies the time-space section that is the classification destination of the acquired record of the traveling data and acquires the representative speed of the relevant time-space section from the representative speed acquiring unit 150. Then, the degree-of-risk calculating unit 160 calculates the degree of risk according to the speed of the automobile corresponding to the specified automobile ID from the acquired traveling data and representative speed. For example, the degree-of-risk calculating unit 160 employs, as the excess speed, the value obtained by subtracting the representative speed of the time-space section that is the classification destination of the traveling data from the speed represented in the traveling data of the specified automobile and further subtracting 5 km/hour (allowable error) from the resulting value. Then, the degree-of-risk calculating unit 160 multiplies each of the excess speeds obtained regarding a respective one of pieces of the traveling data of the specified automobile by the time to the date and time when the next traveling data has been acquired, and employs the total of these values as the degree of risk of the automobile. The degree-of-risk calculating unit 160 outputs the calculated degree of risk to the degree-of-risk offering unit 170.

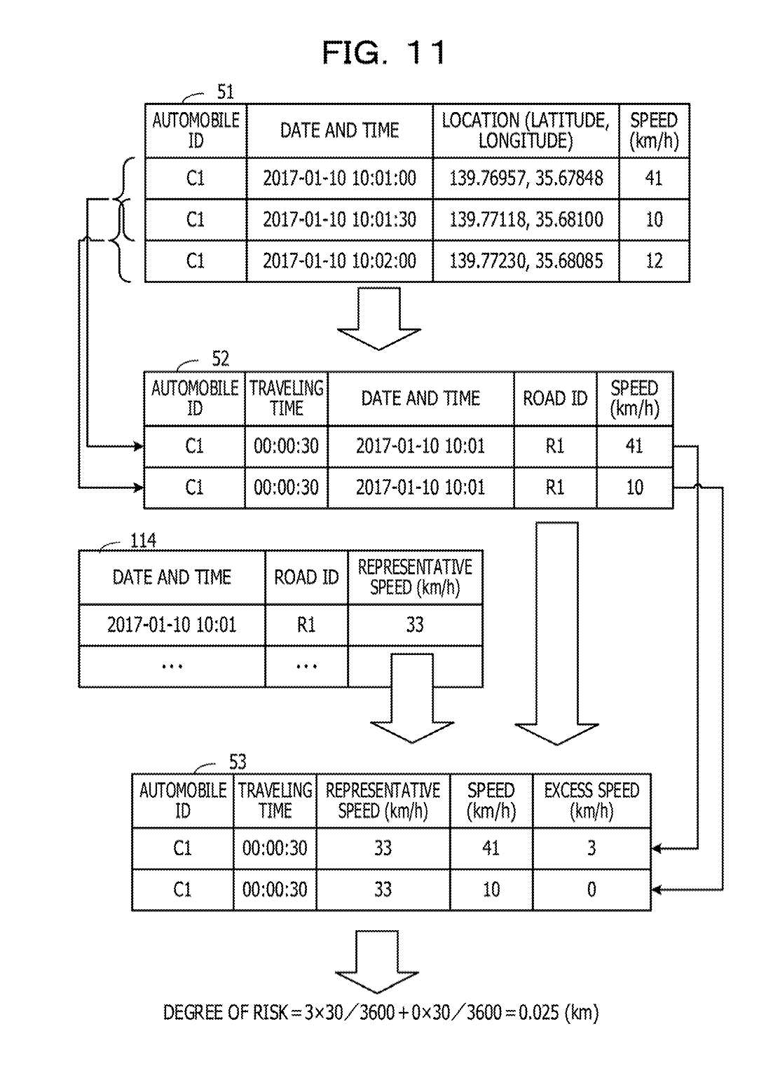

FIG. 11 is a diagram illustrating a calculation example of a degree of risk. In FIG. 11, an example in which the degree of risk according to the speed of the automobile with the automobile ID “C1” is calculated is represented.

First, the degree-of-risk calculating unit 160 acquires traveling data 51 with the automobile ID “C1” from the traveling data management table 111 (see FIG. 6). Next, the degree-of-risk calculating unit 160 obtains the traveling time and the road ID about the records other than the record with the latest date and time. For example, regarding each of the records other than the record, with the latest date and time the degree-of-risk calculating unit 160 calculates the difference from the acquisition date and time of the next record and employs the difference as the traveling time. Furthermore, the degree-of-risk calculating unit 160 transmits each record to the time-space classifying unit 130 and obtains the road ID as a response to the transmission.

After discriminating the traveling time and the road ID, the degree-of-risk calculating unit 160 adds the calculated traveling time to each record of the acquired traveling data 51 and replaces the location by the road ID. In traveling data 52 after the update, the latest record of the traveling data 51 has been deleted. Furthermore, the second scale of the date and time has been deleted in the traveling data 52 after the update.

Next, the degree-of-risk calculating unit 160 acquires the representative speed corresponding to the time-space section (set of the date and time and the road ID) of each record of the traveling data 52 from the representative speed table 114. In the example of FIG. 11, a representative speed “33 km/hour” is obtained. Regarding each record of the traveling data 52, the degree-of-risk calculating unit 160 subtracts the value obtained by adding 5 km/hour to the representative speed from the speed of the record and employs the subtraction result as the excess speed. If the subtraction result is a negative value, the degree-of-risk calculating unit 160 sets the excess speed to “0 km/hour.” When the speed represented in the record of the traveling data 52 is defined as s and the representative speed is defined as r, the excess speed o may be calculated by an expression of “o=max(r, s−5)−r.” “max( )” represents the maximum value among the elements in the parentheses.

The degree-of-risk calculating unit 160 calculates the degree of risk based on an excess speed calculation result 53 obtained by calculating the excess speed of each record of the traveling data 52. For example, the degree-of-risk calculating unit 160 multiplies the excess speed of each record represented in the excess speed calculation result 53 by the traveling time of the record. Then, the degree-of-risk calculating unit 160 employs the sum of the multiplication results of the respective records in the excess, speed calculation result 53 as the degree of risk. In the example of FIG. 11, the degree of risk of the automobile ID “C1” is “3×30/3600+0×30/3600=0.025 (km).”

In the following, explanation of FIG. 5 will be made again.

The degree-of-risk offering unit 170 acquires the degree of risk of the automobile corresponding to an automobile ID specified from the degree-of-risk calculating unit 160 in response to a request for acquisition of the degree of risk with specifying of the automobile ID from the information using server 40. Then, the degree-of-risk offering unit 170 transmits information that represents the degree of risk of the automobile to the information using server 40.

The representative speed offering unit 180 acquires the representative speed of each space section in the immediately-recent time section from the representative speed table 115 in units of one second through the representative speed acquiring unit 150. Then, the representative speed offering unit 180 transmits the immediately-recent representative speed of each space section to pieces of in-car equipment of automobiles that presently exist in the space section. The representative speed offering unit 180 may output the representative speed after correcting the representative speed according to the offering destination of the representative speed. For example, the representative speed offering unit 180 corrects the representative speed according to the type of the automobile of the transmission destination. In this case, the representative speed offering unit 180 deems that the light automobile involves a high accident risk, for example, and transmits r′=r−5 instead of the representative speed r if the automobile of the transmission destination is the light automobile. In the case of carrying out correction according to the type of the automobile as above, the traveling data acquiring unit 120 acquires traveling data including information about whether the automobile is a light automobile from in-car equipment of the automobile. The representative speed offering unit 180 determines whether or not the automobile is a light automobile based on the traveling data acquired from the in-car equipment of the automobile.

The lines that couple the respective elements illustrated in FIG. 5 are what represent part of the communication paths and communication paths other than the communication paths illustrated in FIG. 5 may also be set. Furthermore, functions of each element illustrated in FIG. 5 may be implemented by causing a computer to execute a program module corresponding to the element, for example.

In the system with the above-described configuration, representative speed calculation processing, degree-of-risk offering processing, and representative speed transmission processing are executed. The procedure of each kind of processing will be described below with reference to a flowchart.

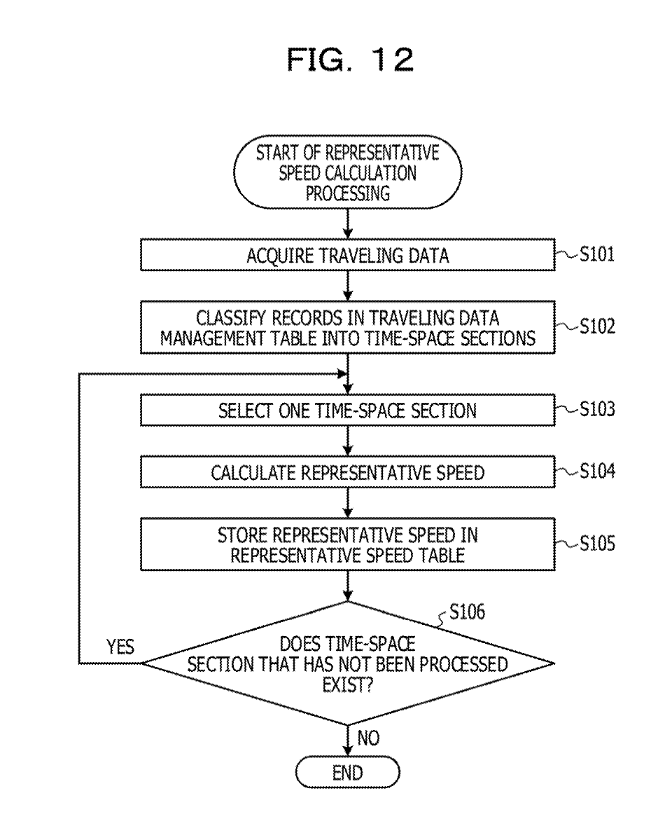

FIG. 12 is a flowchart illustrating one example of a procedure of representative speed calculation processing. The representative speed calculation processing is periodically executed at a certain time interval, for example. The processing represented in FIG. 12 will be described below along the step number.

[Step S101] The traveling data acquiring unit 120 acquires traveling data from in-car equipment of each automobile. Then, the traveling data acquiring unit 120 registers the acquired traveling data in the traveling,data management table 111.

[Step S102] The time-space classifying unit 130 classifies the records in the traveling data management table 111 into time-space sections. Then, the time-space classifying unit 130 stores the time-space-section-specific traveling data groups 112 and 113 including the classified records in the storing unit 110.

[Step S103] The representative speed calculating unit 140 selects.

one time-space section that has not been processed.

[Step S104] The representative speed calculating unit 140 acquires the time-space traveling data table corresponding to the selected time-space section from the time-space-section-specific traveling data group 112 or 113. For example, if the width of the time section of the selected time-space section is one minute, the representative speed calculating unit 140 acquires the time-space traveling data table from the time-space-section-specific traveling data group 112 in units of one minute. Furthermore, if the width of the time section of the selected time-space section is one second, the representative speed calculating unit 140 acquires the time-space traveling data table from the time-space-section-specific traveling data group 113 in units of one second. Then, the representative speed calculating unit 140 calculates the representative speed in the selected time-space section based on the, acquired time-space traveling data table.

[Step S105] The representative speed calculating unit 140 associates the calculated representative speed with the selected time-space action (set of the date and time and the road ID) and stores the representative speed in the representative speed table. For example, the representative speed calculating unit 140 stores the representative speed in the representative speed table 114 in units of one minute if the width of the time section of the selected time-space section is one minute. Furthermore, the representative speed calculating unit 140 stores the representative speed in the representative speed table 115 in units of one second if the width of the time section of the selected time-space section is one second.

[Step S106] The representative speed calculating unit 140 determines whether or not a time-space section that has not been processed exists. If a time-space section that has not been processed exists, the representative speed calculating unit 140 forwards the processing to the step S103. Furthermore, if the calculation of the representative speed has been completed regarding all time-space sections, the representative speed calculating unit 140 ends the representative speed calculation processing.

Thereafter, when a request for acquisition of the degree of risk is input from the information using server 40, the degree-of-risk offering processing is executed.

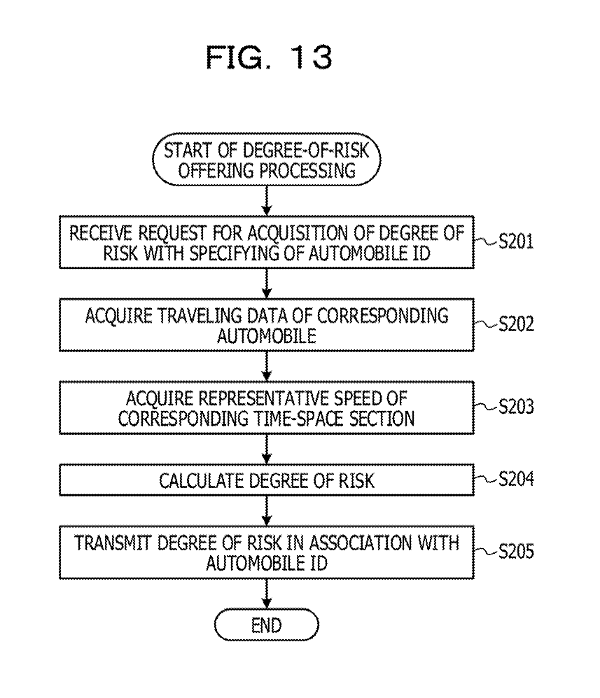

FIG. 13 is a flowchart illustrating one example of a procedure of degree-of-risk offering processing. The processing represented in FIG. 13 will be described below along the step number.

[Step S201] The degree-of-risk offering unit 170 receives a request for acquisition of the degree of risk with specifying of an automobile ID from the information using, server 40. The degree-of-risk offering unit 170 transmits the automobile ID represented in the received request for acquisition of the degree of risk to the degree-of-risk calculating unit 160.

[Step S202] The degree-of-risk calculating unit 160 acquires, from the traveling data management table 111, records that represent traveling data of the automobile corresponding to the automobile ID input from the degree-of-risk offering unit 170.

[Step S203] The degree-of-risk calculating unit 160 acquires the representative speed of the time-space section corresponding to the records of the traveling data acquired in the step S202 through the representative speed acquiring unit 150. For example, the degree-of-risk calculating unit 160 transmits the location (latitude, longitude) of each record of the acquired traveling data to the time-space classifying unit 130. Thereupon, the time-space classifying unit 130 transmits the road ID of the road corresponding to the location to the degree-of-risk calculating unit 160. The degree-of-risk calculating unit 160 specifies the time-space section based on the set of the date and time (second scale is deleted) of each record of the acquired traveling data and the road ID corresponding to the location and requests the representative speed acquiring unit 150 to transmit the representative speed of the time-space section. The representative speed acquiring unit 150 extracts the representative speed of the specified time-space section from the representative speed table 114 and transmits the extracted representative speed to the degree-of-risk calculating unit 160.

[Step S204] The degree-of-risk calculating unit 160 calculates the degree of risk of the automobile corresponding to the automobile ID input from the degree-of-risk offering unit 170 based on the speeds represented in the respective records of the traveling data acquired in the step S202 and the representative speed acquired in the step S203. The concrete calculation method of the degree of risk is as represented in FIG. 11. The degree-of-risk calculating unit 150 transmits the calculated degree of risk to the degree-of-risk offering unit 170.

[Step S205] The degree-of-risk offering unit 170 transmits, to the information using server 40, information in which the degree of risk sent from the degree-of-risk calculating unit 160 is associated with the automobile ID input from the degree-of-risk offering unit 170.

In this manner, information on the degree of risk is offered from the vehicle speed management server 100 to the information using server 40. The degree of risk offered to the information using server 40 may be used for various purposes. For example, as a use scene of the degree of risk according to the speed of the automobile, safe driving management of employee drivers in a land transportation business is conceivable.

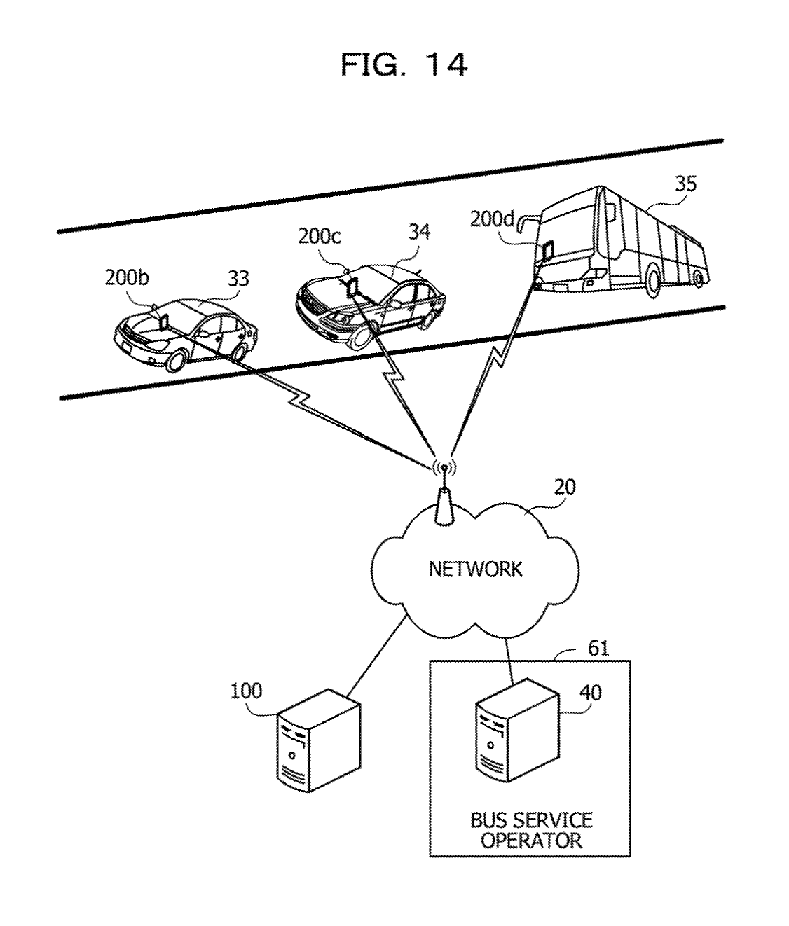

FIG. 14 is a diagram illustrating an example in which a degree of risk according to speed of an automobile is used for safe driving management In the example of FIG. 14, a bus service operator 61 includes the information using server 40. The vehicle speed management server 100 calculates the degree of risk according to the speed of a bus 35 operated by the bus service operator 61 based on traveling data collected from in-car equipment 200d of the bus 35 and pieces of in-car equipment 200b and 200c of other automobiles 33 and 34. Then, the information using server 40 possessed by the bus service operator 61 acquires the degree of risk according to the speed of the bus 35 from the vehicle speed management server 100.

Based on the degree of risk acquired by the information using server 40, the bus service operator 61 may discriminate drivers who tend to make a dangerous speed among a large number of bus drivers, for example. For example, it turns out that, when the degree of risk according to the speed of the bus 35 is higher, the driver who is driving the bus 35 has a higher tendency to drive at a dangerous speed. Therefore, the bus service operator 61 may improve the safety of the bus operation by giving proper guidance about safe driving to the driver having a tendency to drive at a dangerous speed.

Although the example of FIG. 14 is an example of safe driving management by the bus service operator 61, the degree of risk according to the speed may be similarly used for safe driving management also in taxi service operator and truck service operator besides the bus service operator 61.

Furthermore, it is also possible to use the degree of risk according to the speed of the automobile for motivation for safe driving by a discount of an insurance premium of automobile insurance.

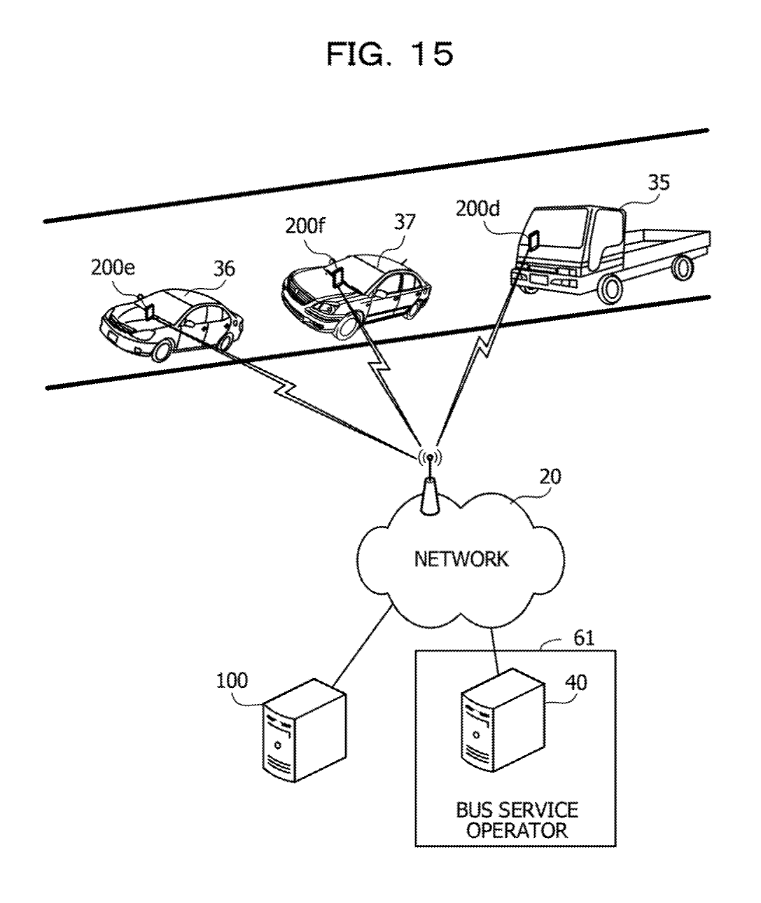

FIG. 15 is a diagram illustrating an example in which a degree of risk according to speed of an automobile is used for motivation for safe driving by a discount of an insurance premium of automobile insurance. In the example of FIG. 15, an insurance business, operator 62 includes the information using server 40. The vehicle speed management server 100 calculates the degrees of risk according to the speeds of the respective automobiles 36 to 38 driven by policyholders based on traveling data collected from pieces of in-car equipment 200e, 200f, and 200g of the automobiles 36 to 38. Then, the information using server 40 possessed by the insurance business operator 62 acquires the degrees of risk according to the speeds of the respective automobiles 36 to 38 from the vehicle speed management server 100.

Based on the acquired degree of risk, the insurance business operator 62 may discriminate a policyholder who tends to make a dangerous speed, for example. For example, it turns out that, when the degrees of risk according to the speeds of the automobiles 36 to 38 are higher, the policyholders who are driving the automobiles 36 to 38 have a higher tendency to drive at a dangerous speed. Therefore, the insurance business operator 62 sets the insurance premium higher about the driver who has a tendency to drive at a dangerous speed than about the driver who does not have a tendency to drive at a dangerous speed. The policyholder may enjoy an inexpensive insurance premium if the policyholder drives at a safe speed. For this reason, it may be expected that the policyholder drives carefully so as not to make an excessively-high speed. As a result, the possibility that the policyholder causes an accident may be lowered and traffic safety on the road may be promoted.

Furthermore, when the vehicle speed management server 100 receives traveling data from in-car equipment of an automobile, representative speed transmission processing to the in-car equipment is executed.

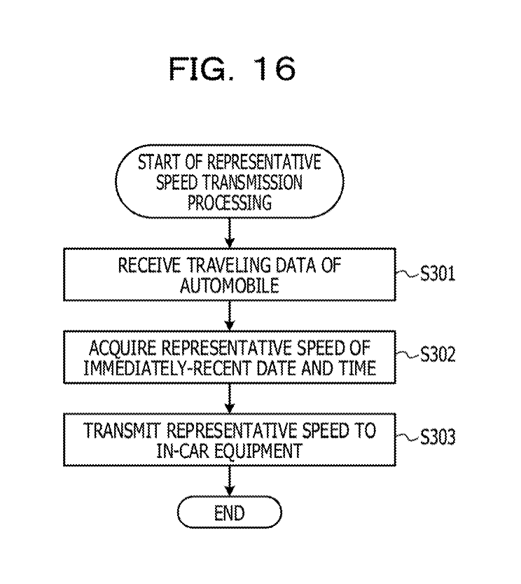

FIG. 16 is a flowchart illustrating one example of a procedure of representative speed transmission processing. The processing represented in FIG. 16 will be described below along the step number.

[Step S301] The traveling data acquiring unit 120 receives traveling data from in-car equipment of an automobile. The traveling data acquiring unit 120 transmits the received traveling data to the representative speed offering unit 180.

[Step S302] The representative speed offering unit 180 acquires, through the representative speed acquiring unit 150, the representative speed of the immediately-recent time section in the space section in which the automobile equipped with the in-car equipment that has transmitted the traveling data presently exists. For example, the representative speed offering unit 180 transmits the location (latitude, longitude) represented in the acquired traveling data to the time-space classifying unit 130. Thereupon, the time-space classifying unit 130 transmits the road ID of the road corresponding to the location to the representative speed offering unit 180. The representative speed offering unit 180 specifies the space section based on the road ID corresponding to the location represented in the acquired traveling data and requests the representative speed acquiring unit 150 to transmit the immediately-recent representative speed of the space section. The representative speed acquiring unit 150 extracts the representative speed of the immediately-recent time section in the specified space section from the representative speed table 115 and transmits the extracted representative speed to the representative speed offering unit 180.

[Step S303] The representative speed offering unit 180 transmits the acquired representative speed to the in-car equipment of the transmission source of the traveling data.

In this manner, the immediately-recent representative speed may be transmitted to in-car equipment of each automobile. The in-car equipment that has received the representative speed may use the representative speed as reference information for speed decision in automatic driving, for example. This may cause the automobile to travel at a speed adjusted to the present speed of surrounding automobiles in automatic driving of the automobile. As a result, automatic driving that goes with the flow of the surrounding automobiles becomes possible and the safety of the automobile may be improved. Furthermore, by displaying the representative speed on the screen of in-car equipment of an automobile driven by a person, the driver may understand the standard speed of surrounding other automobiles and may utilize the standard speed for safe driving.

The degree of risk in the second embodiment becomes higher when the speed excess from the representative speed +5 km/hour is higher and when the traveling time in the state is longer. Because the representative speed is the actual operating speed, the degree of risk calculated about each automobile is an index of the degree of risk in which the influence of the situation around the automobile is reflected.

Furthermore, in the second embodiment, by employing the value lower by 5 km/hour than the amount of excess of the speed of the automobile beyond the representative speed, a small allowance is set between the actual operating speed and the dangerous speed. The purpose thereof is to deter the driver from excessively lowering the speed as the result of intending to lower the degree of risk. For example, if the actual operating speed is used as the threshold for determination of whether or not risk exists (whether or not risk becomes higher than 0) without the correction of subtracting 5 km/hour, there is a possibility that the respective automobiles attempt to travel at a speed lower than the actual operating speed. Then, if a large number of automobiles decrease the speed to a speed lower than the actual operating speed, the actual operating speed decreases over time and the speed gets close to “0.” Due to the correction of subtracting 5 km/hour, the threshold for determination of whether or not risk exists becomes larger than the actual operating speed and therefore it is possible to deter the actual operating speed from decreasing over time.

### Other Embodiments

As the calculation method of the excess speed of the automobile, various calculation methods may be applied. For example, instead of the representative speed, the maximum value in the speed limit and the representative speed in the time-space section may be used. For example, when the speed is defined as s and the representative speed is defined as r and the speed limit is defined as L, the excess speed o may be defined as o=max(L, r, s−5)−max(L, r). The speed limit in the relevant time-space section may be acquired from data released from a public administration or the like. By calculating the excess speed also in consideration of the speed limit as above, the driver may be kept from suffering from a disadvantage although travelling at the speed limit. Furthermore, the possibility that the actual operating speed gets closer to “0” over time may also be further reduced.

Moreover, correction according to, the type of automobile and the weather condition may be carried out in the calculation of the excess speed, for example. For example, it may be deemed that the light automobile involves a high accident risk and the excess speed may be calculated by using s′=s+5 instead of the speed s when the automobile is a light automobile. Information about whether or not the automobile is a light automobile may be acquired from in-car equipment as part of traveling data, for example. Furthermore, for example, it may be deemed that traveling in a strong wind involves a high accident risk and the original excess speed may be multiplied by a correction coefficient such as 1.5 to employ the multiplication result as the final excess speed if the time-space section in which the automobile of the target of calculation of the degree of risk has traveled is a section with a strong wind. Information about whether or not the time-space section is a section with a strong wind is acquired from meteorological data or the like released from a public administration or the like. By such correction, the difference in the accident risk due to the type of automobile and the weather condition may be properly reflected.

Although the case in which the moving object is the automobile represented in the second embodiment, the similar degree-of-risk calculation technique may be applied also to moving objects other than the automobile. For example, as the moving objects, there are pedestrian, bicycle, motorcycle, aircraft, and so forth. Furthermore, driverless objects such as a drone are also included in the moving objects.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory configured to store first information that represents a target object, second information that represents a target time section, and third information that represents a target space section; and
a processor coupled to the memory and configured to:
regarding each of a plurality of objects, acquire a record including location information that represents a location of the object, speed information that represents a movement speed of the object, time information that represents a time at which the location information and the speed information have been acquired and identification information of the object;
identify, from the plurality of records, a first record including the identification information corresponding to the target object, the time information corresponding to the target time section, and the location information corresponding to the target space section;
identify, from the plurality of records, a plurality of second records each of which includes the time information corresponding to the target time section and the location information corresponding to the target space section;
identify a degree of risk of the target object based on difference between a representative value of the speed information included in the plurality of second records and the speed information included in the first record; and
output the identified degree of risk.

2. The information processing apparatus according to claim 1, wherein
the representative value is an N-th percentile value (N is a real number in a range of 0 to 100 inclusive) of a plurality of speeds represented by the speed information included in each of the plurality of second records.

3. The information processing appapparatus according to claim 1, wherein the processor is configured to:
generate a plurality of time-space sections each obtained by combining one time section in a plurality of time sections and one space section in a plurality of space sections;
classify each of the plurality of records into any of the plural of time-space sections based on the time information and the location information;
identify the representative value based on the speed information of the plurality of records classified into each of the plurality of time-space sections;
store, in the memory, the representative value of each of the plurality of time-space sections;
identify a target time-space section corresponding to a set of the target time section and the target space section from the plurality of time-space sections;
acquire, from the memory, the representative value of the identified target time-space section; and
identify the degree of risk of the target object based on difference between the representative value and the speed information included in the first record.

4. The information processing apparatus according to claim 1, wherein the processor is configured to:
identify the difference between the speed information included in the first record and the representative value; and
identify the degree of risk based on a result of multiplication of the difference and a movement time of the target object.

5. The information processing apparatus according to claim 4, wherein
the difference is a value obtained by subtracting a value resulting from addition of an allowable error to the representative value from the speed information included in the first record.

6. The information processing apparatus according to claim 4, wherein the processor is configured to:
when a plurality of records exist as the first records, identify the difference regarding each of the plurality of first records;
identify a result of multiplication of the difference and a movement time of the target object regarding each of the plurality of first records; and
identify total of the results of multiplication of the plurality of first records as the degree of risk.

7. The information processing apparatus according to claim 1, herein the processor is configured to:
identify a third record including the location information that represents a location in the target space section; and
notify the target moving object of the representative value of the third record.

8. A method comprising:
acquiring first in formation that represents a target object, second information that represents a target time section, and third information that represents a target space section;
regarding each of a plurality of objects, acquiring a record including location information that represents a location of the object, speed information that represents a movement speed of the object, time information that represents a time at which the location information and the speed information have been acquired, and identification information of the object;
identifying, from the plurality of records, a first record including the identification information corresponding to the target object, the time information corresponding to the target time section, and the location information corresponding to the target space section;
identifying, from the plurality of records, a plurality of second records each of which includes the time information corresponding to the target time section and the location information corresponding to the target space section;
identifying a degree of risk of the target object based on difference between a representative value of the speed information included in the plurality of second records and the speed information included in the first record; and
outputting the identified degree of risk.

9. The method according to claim 8, wherein
the representative value is an N-th percentile value (N is a real number in a range of 0 to 100 inclusive) of a plurality of speeds represented by the speed information included in each of the plurality of second records.

10. The method according to claim 8, further comprising:
generating a plurality of time-space sections each obtained by combining one time section in a plurality of time sections and one space section in a plurality of space sections;
classifying each of the plurality of records into any of the plurality of time-space sections based on the time information and the location information;
identifying the representative value based on the speed information of the plurality of records classified into each of the plurality of time-space sections;
storing, in the memory, the representative value of each of the plurality of time-space sections;
identifying a target time-space section corresponding to a set of the target time section and the target space section from the plurality of time-space sections;
acquiring, from the memory, the representative value of the identified target time-space section; and
identifying the degree of risk of the target object based on difference between the representative value and the speed information included in the first record.

11. The method according to claim 8, further comprising:
identifying the difference between the speed information included in the first record and the representative value; and
identifying the degree of risk based on a result of multiplication of the difference and a movement time of the target object.

12. The method according to claim 11, wherein
the difference is a value obtained by subtracting a value resulting from addition of an allowable error to the representative value from the speed information included in the first record.

13. The method according to claim 11, further comprising:
when a plurality of records exist as the first records, identifying the difference regarding each of the plurality of first records;
identifying a result of multiplication of the difference and a movement time of the target object regarding each of the plurality of first records; and
identifying total, of the results of multiplication of the plurality of first records as the degree of risk.

14. The method according to claim 8, further comprising:
identifying a third record including the location information that represents a location in the target space section; and
notifying the target moving object of the representatively the third record.

15. A non-transitory computer-readable storage medium storing a program that causes an information processing apparatus to execute a process, the process comprising:
acquiring first information that represents a target object, second information that represents a target time section, and third information that represents a target space section;
regarding each of a plurality of objects, acquiring a record including location information that represents a location of the object, speed information that represents a movement speed of the object, time information that represents a time at which the location information and the speed information have been acquired, and identification information of the object;
identifying, from the plurality of records, a first record including the identification information corresponding to the target object, the time information corresponding to the target time section, and the location information corresponding to the target space section;
identifying, from the plurality of records, a plurality of second records each of which includes the time information corresponding to the target time section and the location information corresponding to the target space section;
identifying a degree of risk of the target object based on difference between a representative value of the speed information included in the plurality of second records and the speed information included in the first record; and
outputting the identified degree of risk.

16. The non-transitory computer-readable storage medium according to claim 15, wherein
the representative value is an N-th percentile value (N is a real number in a range of 0 to 100 inclusive) of a plurality of speeds represented by the speed information included in each of the plurality of second records.

17. The non-transitory computer-readable storage medium according to claim 15, the process further comprising:
generating a plurality of time-space sections each obtained by combining one time section in a plurality of time sections and one space section in a plurality of space sections;
classifying each of the plurality of records into any of the plurality of time-space sections based on the time information and the location information;
identifying the representative value based on the speed information of the plurality of records classified into each of the plurality of time-space sections;
storing, in the memory, the representative value of each of the plurality of time-space sections;
identifying a target time-space section corresponding to a set of the target time section and the target space section from the plurality of time-space sections;
acquiring, from the memory, the representative value of the identified target time-space section; and
identifying the degree of risk of the target object based on difference between the representative value and the speed information included in the first record.

18. The non-transitory computer-readable storage medium according to claim 15, the process further comprising:
identifying the difference between the speed information included in the first record and the representative value; and
identifying the degree of risk based on a result of multiplication of the difference and a movement time of the target object.

19. The non-transitory computer-readable storage medium according to claim 8, wherein
the difference is a value obtained by subtracting a value resulting from addition of an allowable error to the representative value from the speed information included in the first record.

20. The non-transitory computer-readable storage medium according to claim 18, the process further comprising:
when a plurality of records exist as the first records, identifying the difference regarding each of the plurality of first records;
identifying a result of multiplication of the difference and a movement time of the target object regarding each of the plurality of first records; and
identifying total of the results of multiplication of the plurality of first records as the degree of risk.
